(19) United States
(12) Patent Application Publication
(10) Pub. No.: US 2003/0026329 A1
(43) Pub. Date: Feb. 6, 2003

(54) Digital matched filter performing despread processing by correlation value calculation and mobile wireless terminal including the same

(75) Inventor: Shoji Goto, Gifu-shi (JP)

Correspondence Address: ARMSTRONG,WESTERMAN & HATTORI, LLP, 1725 K STREET, NW., SUITE 1000, WASHINGTON, DC, 20006, US

(73) Assignee: Sanyo Electric Co., Ltd., Moriguchi-shi (JP)

(21) Appl. No.: 10/207,074

(22) Filed: Jul. 30, 2002

(30) Foreign Application Priority Data
Jul. 31, 2001 (JP) 2001-231615(P)

(51) Int. Cl. H04B 1/69

(52) U.S. Cl. 375/152

(57) ABSTRACT

A digital matched filter includes a spread code generating unit, a spread code holding unit, a reception signal holding unit, a tap calculating unit, an adding unit and a correction value generating unit. To the tap calculating unit, a tap output is provided from the reception signal holding unit, and a tap coefficient is provided from the spread code holding unit. A code control unit is provided in the tap calculating unit for each corresponding tap output and tap coefficient. The code control unit provides an output corresponding to the tap output with or without inversion in accordance with the tap coefficient. A correction value generated by the correction value generating unit is added to the sum of the outputs from the code control units. Thus, an error in a correlation value output is corrected.

### BACKGROUND OF THE INVENTION

1. Field of the Invention

The present invention relates to a digital matched filter and a mobile wireless terminal using the same, and more particularly, to a digital matched filter for performing a despread processing at a reception side and a mobile wireless terminal including such a digital matched filter, in a direct sequence spread spectrum communication system.

2. Description of the Background Art

Conventionally, in a digital radio communication such as a CDMA (Code Division Multiple Access) system, a direct sequence spread spectrum communication system has been adopted, in which transmission digital data is scrambled and emitted with a spread code sequence specific to a user and received digital data is descrambled with a despread code sequence on a reception side.

On a transmission side of the digital radio communication using such direct sequence spread spectrum communication system, a spread unit for generating a spread code sequence for scrambling the transmission digital data is provided. On the other hand, on the reception side, a despread unit for generating a replica signal of the spread code sequence for descrambling the received digital data is provided.

FIG. 8 is a schematic block diagram showing a basic configuration of a transmitter and a receiver in the direct sequence spread spectrum communication system as described above.

Referring to FIG. 8, the direct sequence spread spectrum communication system basically includes a transmitter 60 and a receiver 65.

In transmitter 60, an original signal to be transmitted is provided to a primary modulator 61. In view of efficient use of a radio wave, a signal band is narrowed.

An output from primary modulator 61 is provided to a spread unit 62, and is spread, that is, scrambled (secondary modulation), with the spread code sequence supplied from a spread code generating unit (not shown) provided inside.

An output from spread unit 62 is transmitted via an antenna 63 after undergoing a necessary processing for radio transmission by a transmission circuit (not shown).

A signal transmitted from antenna 63 is received by an antenna 64 of receiver 65, and provided to a despread unit 66 after undergoing a necessary processing for radio reception by a reception circuit (not shown).

Despread unit 66 mainly includes a digital matched filter. The digital matched filter despreads, that is, descrambles, a reception signal with a replica signal in synchronization with the spread code sequence on the reception side, supplied from the spread code generating unit (not shown) provided inside. More specifically, the digital matched filter calculates and outputs a correlation value of the input reception signal with the replica signal of the spread code sequence generated internally.

Thus, a synchronization timing of the spread code is detected by despread unit 66, a primary modulation signal is taken out by despreading, and the original signal is demodulated by a demodulating unit 67.

The digital matched filter is adopted for code synchronization processing because of its high speed in calculating the correlation value of the reception signal with the spread code. Such digital matched filter is described in detail, for example, in “A Development Conditions and Its Technical Issue of Digital Matched Filters in Spread-Spectrum Communication Systems” by Tachika, in IEICE Technical Report SST92-21.

In the following, a configuration and an operation of a conventional digital matched filter will be described in detail.

FIG. 9 is a block diagram showing a configuration of a transversal filter as an example of the conventional digital matched filter. Referring to FIG. 9, the digital matched filter includes a spread code generating unit 11, a spread code holding unit 12, a reception signal holding unit 13, a tap calculating unit 14 and an adding unit 15.

Spread code generating unit 11 has a configuration, in which, for example, a certain initial value specific to a system is set in a shift register (not shown) configured so as to implement a prescribed generating polynomial, a shift operation is performed a prescribed times based on the initial value, and then, a spread code sequence already known on the transmission and reception sides is sequentially output. Here, in spread spectrum, a spread code of one bit is particularly called a “chip”, and the number of chips for one cycle of the spread code is called “spread code length”.

Chips of a spread code length generated in spread code generating unit 11 are input to spread code holding unit 12 with a chip rate of the spread code, and stored therein as tap coefficients of the digital matched filter. In addition, control signal described below is provided to spread code holding unit 12 from spread code generating unit 11.

FIG. 10 is a block diagram showing a detailed configuration of spread code holding unit 12 shown in FIG. 9. Referring to FIG. 10, spread code holding unit 12 is a shift register composed of 1-bit registers S having the number of stages corresponding to the spread code length (for example, 256 stages if the spread code length is set to 256 chips). A gate G is provided at a preceding stage of register S at each stage.

Each of gates G selectively passes an output from a register either at the preceding stage or a subsequent stage, in response to a control signal provided from spread code generating unit 11, and provides the output to an input of the register at the subsequent stage.

An operation of spread code holding unit 12 in FIG. 10 will now be described. During a period in which the spread codes with a spread code length (256 chips, for example) are output from spread code generating unit 11, a control signal output from spread code generating unit 11 is assumed to have a value of 0, for example.

During a period in which the control signal with the value of 0 is commonly provided to control inputs of all gates G constituting spread code holding unit 12 of FIG. 10, each gate G passes an output from the preceding stage to register S at the subsequent stage as it is. Consequently, the spread codes output from spread code generating unit 11 are sequentially stored in a shift register constituting spread code holding unit 12.

When output of the spread codes with the spread code length from spread code generating unit 11 ends, it is assumed that the control signal output from spread code generating unit 11 makes a transition, for example, from 0 to 1.

When the control signal with a value of 1 is commonly provided to control inputs of all gates G constituting spread code holding unit 12, each gate G is switched to select an output from the subsequent stage, and a shift operation of the shift register stops. The spread codes with the spread code length are thus held in spread code holding unit 12.

Here, the spread codes with the spread code length (256 chips, for example) stored in respective stages of the shift register are taken out in parallel, and are provided to tap calculating unit 14 in FIG. 9 as tap coefficients C0, C1, C2, . . . , Cn−2, Cn−1, Cn.

Meanwhile, a reception signal consisting of samples each quantized to m bit (m is an integer ≧1) is oversampled with an oversampling rate M times (M is an integer ≧1) larger than the chip rate of the spread code, and time-sequentially input to reception signal holding unit 12. Reception signal samples with a code length being M times of the spread code length are then sequentially stored. For the sake of simplicity, an example will be described, in which the oversampling number of the reception signals (the number of samples/the number of chips) is M=2. The number of quantized bits m is assumed as 6 bits, for example.

FIG. 11 is a block diagram showing a detailed configuration of reception signal holding unit 13 shown in FIG. 9. Referring to FIG. 11, reception signal holding unit 13 is a shift register including 6-bit registers T of the number of stages of ((spread code length×the oversampling number)−1) (511 stages if the spread code length is set to 256 chips, for example), and sequentially stores samples (511 samples, for example), each having 6 bits, of the time-sequentially input reception signal.

At a certain timing, among the reception signal sequences of the above number of samples accumulated in reception signal holding unit 13 which is a shift register, samples held in registers at every other stage (odd-numbered stages) starting from a register at the first stage are taken out in parallel (256 samples, if a shift register has 511 stages, for example), and are provided to tap calculating unit 14 in FIG. 9 as tap outputs R0, R1, . . . Rn−1, Rn.

The tap coefficients C0, C1, . . . , Cn−1, Cn provided from spread code holding unit 12 are multiplied in tap calculating unit 14 by corresponding tap outputs R0, R1, . . . , Rn−1, Rn provided from reception signal holding unit 13, and multiplication results X0, X1, . . . , Xn are provided to adding unit 15.

All multiplication results are added in adding unit 15, and the sum is output as a correlation value at that timing.

At a next timing, a next 6-bit sample of the reception signal sequence is input to reception signal holding unit 13, and the sample held at each stage in FIG. 11 is shifted to a next stage. At this timing, samples (tap outputs) held in the registers at the odd-numbered stages of the shift register are multiplied in tap calculating unit 14 by chips (tap coefficients) with the spread code length stored in spread code holding unit 12, as described above. The sum of the results is calculated by adding unit 15, and is output as a correlation value output at that timing.

The correlation value output is provided, for example, to a cyclic integration unit (not shown) and averaged. A correlation value peak detected as a result is used for initial synchronization with the spread code sequence of the transmitter, for example.

Thus, in digital matched filter 10 in FIG. 9, the reception signal samples input to the shift register constituting reception signal holding unit 13 are subjected to correlation value calculation as tap outputs every other stage. Meanwhile, correlation value calculation is performed each time a succeeding sample is input and samples at respective stages are shifted. Therefore, all samples of the oversampled input reception signal will be subjected to correlation value calculation.

Note that the number of chips of the spread code stored in spread code holding unit 12 does not necessarily correspond to the number of chips comparable to the spread code length for one cycle. In other words, even for a spread code having a portion of one cycle, if it is calculated with reception signal samples corresponding to the number of chips thereof, calculation of the correlation value is possible.

As one manner for multiplication of a tap coefficient by a tap output in tap calculating unit 14, a method is known, in which a multiplication output is obtained by controlling the sign of a reception signal sample (tap output) in accordance with a value of a spread code (tap coefficient) without using a multiplier. Such a method is disclosed, for example, in Japanese Patent Laying-Open No. 10-285079.

Usually, the spread code sequence is a signal sequence including 1-bit codes. In multiplication, binary number 0 is read as decimal number 1, and binary number 1 is read as decimal number −1, for multiplication. Therefore, when the spread code (tap coefficient) is 0, the reception signal sample of m bits (tap output) is provided as it is to the adding unit as a multiplication result.

On the other hand, when the spread code (tap coefficient) is 1, the sign of the reception signal sample of m bits is inverted. Generally, when the sign of a number represented as a 2's complement is inverted, a processing, in which +1 is added to a number having all bits thereof inverted, is performed. In other words, a value simply having all bits of a sample inverted will be a value smaller by 1 than the proper inverted value. Therefore, when the tap coefficient is 1, +1 is added to the least significant bit of the inverted value of the sample of m bits for carrying, and this number is provided as a multiplication result to the adding unit.

FIG. 12 is a block diagram showing a configuration of tap calculating unit 14 which performs multiplication of a tap coefficient by a tap output by controlling such inversion of the sign.

Referring to FIG. 12, tap calculating 14 includes a plurality of (256, for example) code control units 14-0, 14-1, . . . , 14-n, each provided for corresponding tap coefficient C and tap output R.

All of these code control units have the same configuration, including an inverter INV, a +1 adder ADD and a selector SEL.

For example, looking at code control unit 14-0, a 6-bit reception signal sample (tap output) is provided to one input of selector SEL, and has all bits inverted by inverter INV. Addition of +1 to the least significant bit of the inverted tap output is performed by +1 adder ADD, and the output is provided to the other input of selector SEL.

A corresponding 1-bit spread code (tap coefficient) is provided to a control input of selector SEL. When the spread code is 0, a 6-bit tap output as it is (not inverted) provided to one input of selector SEL is selected, and is supplied as multiplication result X0.

On the other hand, when the spread code is 1, the tap output that is inverted, incremented by +1 and provided to the other input of selector SEL is selected, and is supplied as multiplication result X0.

Remaining code control units 14-1 to 14-n also operate in a similar manner, and output multiplication results X1 to Xn. The sum of these outputs X0 to Xn is calculated by adding unit 15 in FIG. 9, and is supplied as a correlation value output.

As described above, in the aforementioned conventional digital matched filter, the reception signal sequence is input to the shift register having stages of the number substantially proportional to the spread code length (for instance, in an example of FIG. 11, stages of ((spread code length×the oversampling number)−1)). A register outputs (tap outputs) at odd-numbered stages among the stages are multiplied by the spread codes (tap coefficients) of the corresponding number of chips (spread code length), using a plurality of code control units each provided for corresponding tap output and tap coefficient.

Therefore, as the spread code length increases, the number of tap coefficients and tap outputs to be calculated will increase. Accordingly, the number of code control units provided in tap calculating unit 14 shown in FIG. 12 also increases, resulting in larger circuit scale of the digital matched filter.

### SUMMARY OF THE INVENTION

An object of the present invention is to provide a digital matched filter of which circuit scale is reduced and a mobile wireless terminal using such a digital matched filter.

One aspect of the present invention is a digital matched filter for performing a despread processing on a reception side to a reception signal sequence subjected to a spread processing on a transmission side. The reception signal sequence is composed of samples each having a prescribed number of bits. The digital matched filter includes a reception signal holding unit, a spread code supply unit and a correlation value calculating unit. The reception signal holding unit sequentially holds a prescribed number of the samples constituting the reception signal sequence that is time-sequentially input. The spread code supply unit supplies a spread code sequence for the despread processing. The correlation value calculating unit calculates a correlation value of at least a portion of the prescribed number of samples held in the reception signal holding unit with a spread code corresponding to at least the portion of the samples in the supplied spread code sequence. The correlation value calculating unit includes a plurality of code control units each provided for corresponding sample and spread code, and an adding unit calculating a sum of outputs from the plurality of code control units. Each of the plurality of code control units outputs a corresponding sample as it is when a corresponding spread code has a first value, and provides an output having the prescribed number of bits of a corresponding sample all inverted when the corresponding spread code has a second value different from the first value.

Preferably, the correlation value calculating unit further includes a correction unit adding as a correction value, the number of codes having the second value among the spread codes corresponding to at least the portion of the samples to the sum calculated in the adding unit.

Preferably, the correction unit includes a count unit counting a number of codes having the second value among the spread codes corresponding to at least the portion of the samples and supplying the number as the correction value.

Preferably, the supplied spread code sequence is a fixed spread code sequence. The correction unit includes a holding unit holding in advance as the correction value, the number of codes having the second value among the fixed spread codes corresponding to at least the portion of the samples.

According to another aspect of the present invention, a mobile wireless terminal for digital radio communication includes a reception-related modem demodulating received digital data, and a signal processing device processing and outputting a reception signal of the reception-related modem. The reception-related modem includes a digital matched filter for performing a despread processing on a reception side to a reception signal sequence subjected to a spread processing on a transmission side. The reception signal sequence is composed of samples each having a prescribed number of bits. The digital matched filter includes a reception signal holding unit, a spread code supply unit and a correlation value calculating unit. The reception signal holding unit sequentially holds a prescribed number of the samples constituting the reception signal sequence that is time-sequentially input. The spread code supply unit supplies a spread code sequence for the despread processing. The correlation value calculating unit calculates a correlation value of at least a portion of the prescribed number of samples held in the reception signal holding unit with a spread code corresponding to at least the portion of the samples in the supplied spread code sequence. The correlation value calculating unit includes a plurality of code control units each provided for corresponding sample and spread code, and an adding unit calculating a sum of outputs from the plurality of code control units. Each of the plurality of code control units outputs a corresponding sample as it is when a corresponding spread code has a first value, and provides an output having the prescribed number of bits of a corresponding sample all inverted when the corresponding spread code has a second value different from the first value.

Preferably, the correlation value calculating unit further includes a correction unit adding as a correction value, the number of codes having the second value among the spread codes corresponding to at least the portion of the samples to the sum calculated in the adding unit.

Preferably, the correction unit includes a count unit counting the number of codes having the second value among the spread codes corresponding to at least the portion of the samples and supplying the number as the correction value.

Preferably, the supplied spread code sequence is a fixed spread code sequence. The correction unit includes a holding unit holding in advance as the correction value, the number of codes having the second value among the fixed spread codes corresponding to at least the portion of the samples.

As described above, according to the present invention, a configuration of each of a plurality of code control units constituting a correlation value calculating unit can be simplified, and in addition, a configuration of a digital matched filter can be simplified.

Further, according to the present invention, outputs from the correlation value calculating unit are corrected collectively. Thus, a configuration of each code control unit can be simplified, and a correlation value output without an error can be obtained.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram showing an overall configuration of a mobile wireless terminal for digital radio communication, to which a digital matched filter according to the present invention is applied.

FIG. 2 is a schematic block diagram showing the digital matched filter in a first embodiment of the present invention, applied to the mobile wireless terminal shown in FIG. 1.

FIG. 3 is a block diagram showing a configuration of a tap calculating unit 16 shown in FIG. 2.

FIG. 4 is a schematic block diagram showing the digital matched filter in a second embodiment of the present invention, applied to the mobile wireless terminal shown in FIG. 1.

FIGS. 5A and 5B are diagrams comparing a property in the first embodiment shown in FIG. 2 with that in the second embodiment shown in FIG. 4.

FIG. 6 is a block diagram showing a configuration of a digital matched filter 31 for P-SCH complying with a mode defined by 3 GPP.

FIG. 7 is a diagram schematically and visually showing an effect of reducing a circuit scale, according to the present invention.

FIG. 8 is a schematic block diagram showing a basic configuration of a transmitter and a receiver in a direct sequence spread spectrum communication system.

FIG. 9 is a schematic block diagram showing a configuration of a conventional digital matched filter.

FIG. 10 is a block diagram showing a configuration of a spread code holding unit 12 shown in FIG. 9.

FIG. 11 is a block diagram showing a configuration of a reception signal holding unit 13 shown in FIG. 9.

FIG. 12 is a block diagram showing a configuration of a tap calculating unit 14 shown in FIG. 9.

### DESCRIPTION OF THE PREFERRED EMBODIMENTS

In the following, embodiments of the present invention will be described in detail with reference to the figures. It is noted that the same reference characters refer to the same or corresponding components in the figures.

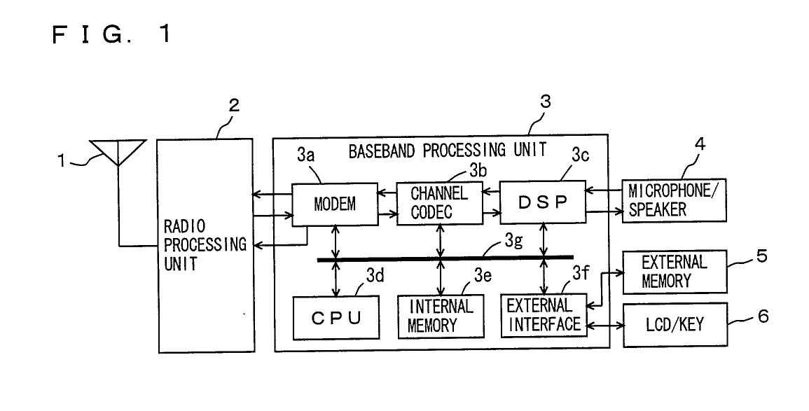

FIG. 1 is a schematic block diagram showing an overall configuration of a mobile wireless terminal for digital radio communication, to which a digital matched filter according to the present invention is applied.

The mobile wireless terminal shown in FIG. 1 includes, as main components, an antenna 1, a radio processing unit 2, a baseband processing unit 3, a speech input/output device 4 having a microphone and a speaker, an external memory 5 and a display/input device 6 having an LCD and keys.

In particular, baseband processing unit 3 includes a modem 3a, a channel codec 3b, a DSP 3c, a CPU 3d, an internal memory 3e, an external interface 3f and an internal bus 3g.

A radio wave signal from a base station (not shown) received by antenna 1 is converted to a baseband signal by radio processing unit 2, and provided to baseband processing unit 3.

In baseband processing unit 3, a reception signal is demodulated by modem 3a, further decoded by channel codec 3b, and provided to DSP 3c. DSP 3c performs data processing of the reception signal for driving the speaker of speech input/output device 4, and converts the reception signal to speech.

Meanwhile, the speech input via the microphone of speech input/output device 4 is subjected to data processing in DSP 3c, and provided to channel codec 3b. Channel codec 3b encodes the provided speech signal, and supplies the signal to modem 3a. Modem 3a modulates the supplied transmission signal, and provides the signal to radio processing unit 2. Radio processing unit 2 performs radio processing of the transmission signal, and emits the signal via antenna 1 to a base station (not shown).

Here, modem 3a, channel codec 3b and DSP 3c are connected to CPU 3d, internal memory 3e and external interface 3f, via internal bus 3g. CPU 3d controls an overall operation of the mobile wireless terminal in FIG. 1 in accordance with a program stored in internal memory 3e. In addition, external interface 3f performs a function as an interface with external memory 5 and display/input device 6.

(First Embodiment)

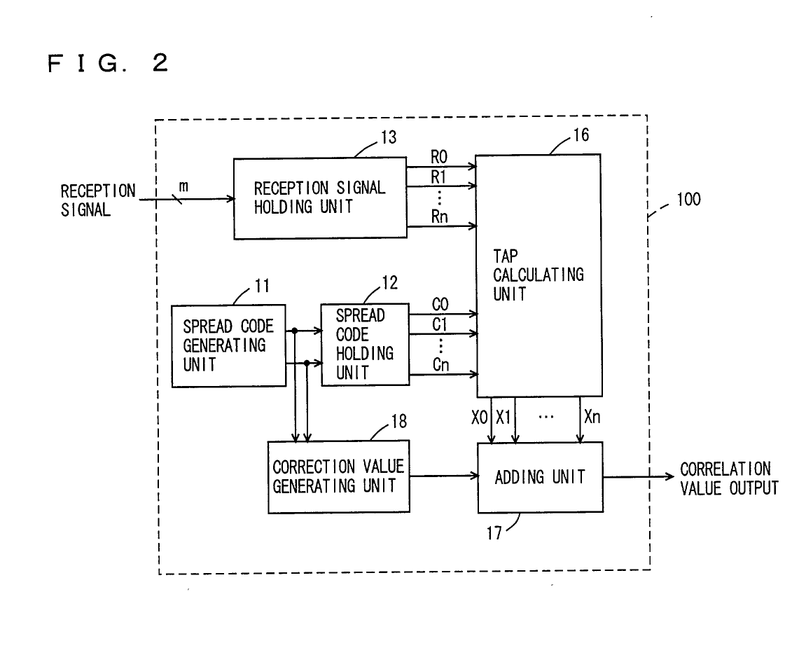

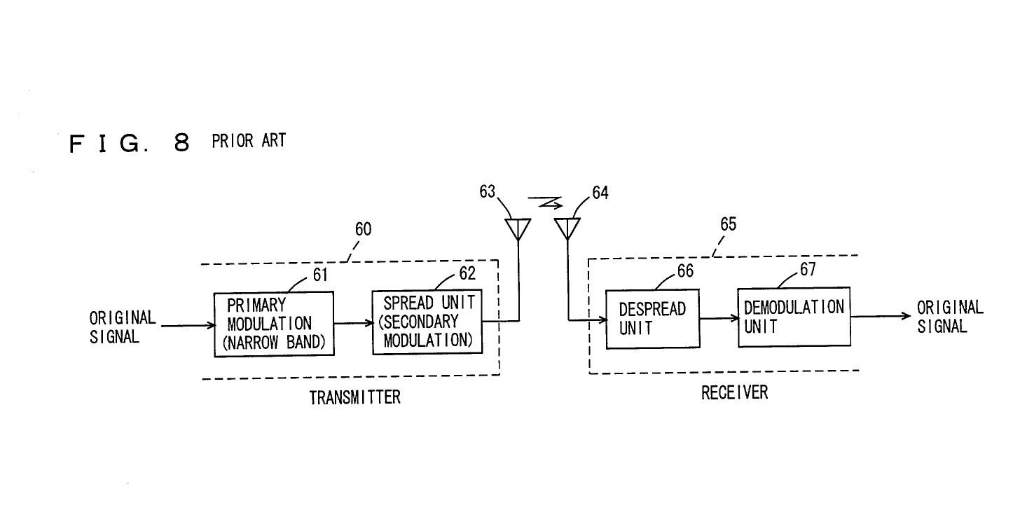

FIG. 2 is a schematic block diagram showing a digital matched filter 100 in a first embodiment of the present invention, applied to the mobile wireless terminal shown in FIG. 1. Here, despread unit 66 and demodulating unit 67 of receiver 65 shown in FIG. 8 generally constitute a reception-related modem unit (not shown) within modem 3a of baseband processing unit 3 of the mobile wireless terminal in FIG. 1. Therefore, it is assumed that digital matched filter 100 in the embodiment shown in FIG. 2 is also included in the reception-related modem unit.

Referring to FIG. 2, digital matched filter 100 according to the first embodiment of the present invention includes a spread code generating unit 11, a spread code holding unit 12, a reception signal holding unit 13, a tap calculating unit 16, an adding unit 17 and a correction value generating unit 18.

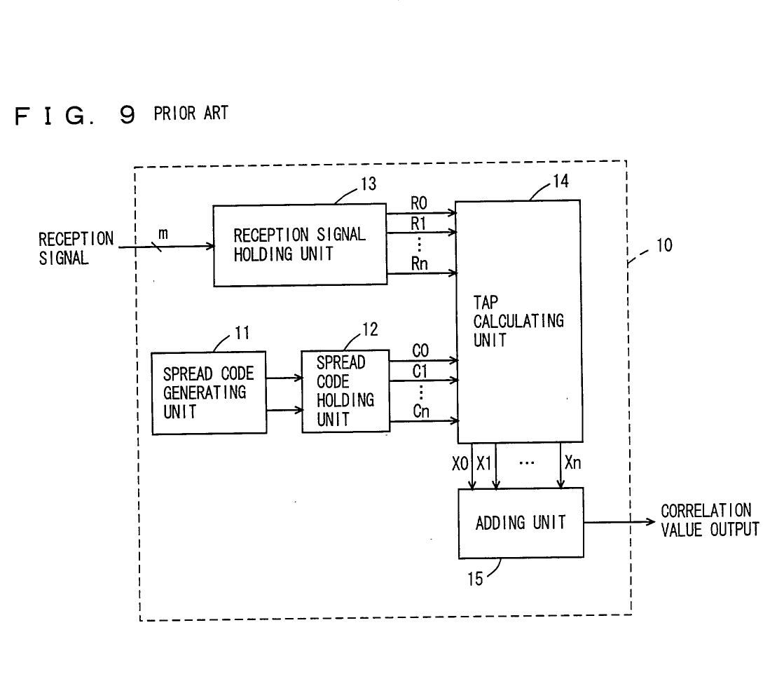

Since spread code generating unit 11, spread code holding unit 12 and reception signal holding unit 13 are the same as spread code generating unit 11, spread code holding unit 12 and reception signal holding unit 13 in the conventional digital matched filter 10 described with reference to FIGS. 9 to 11, description thereof will not be repeated.

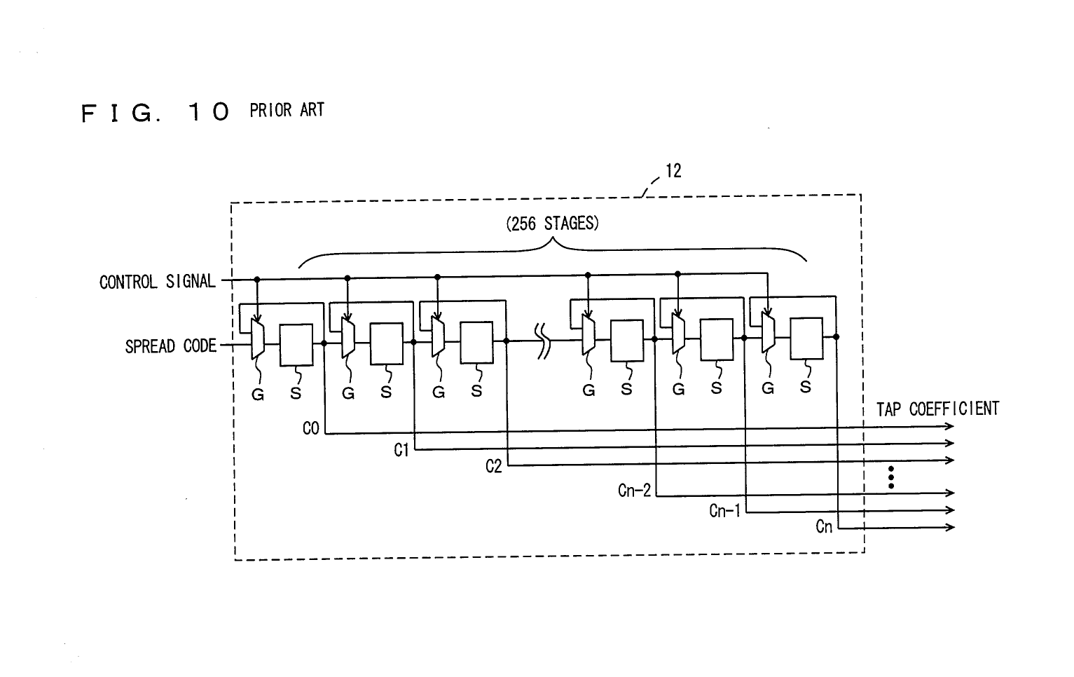

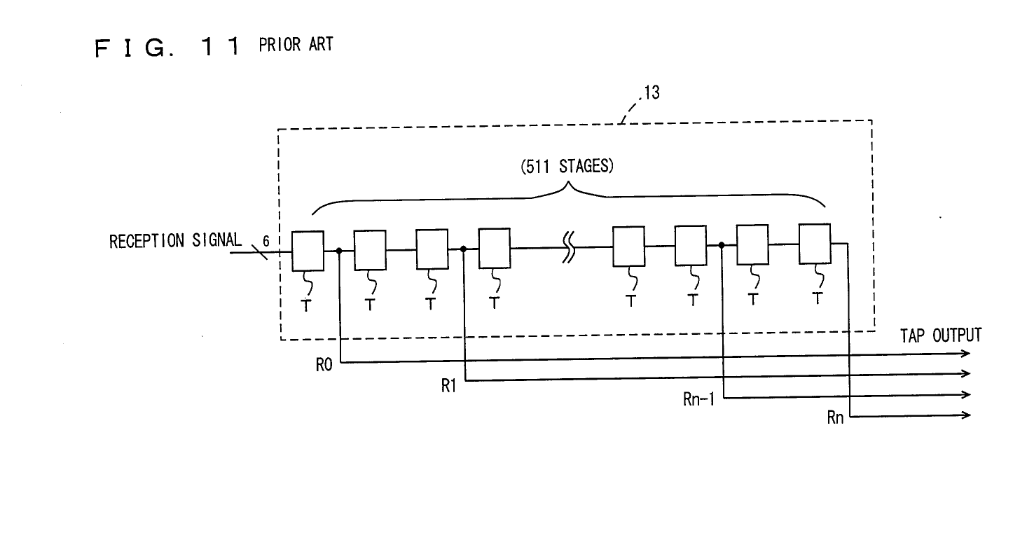

Spread codes (tap coefficients) C0, C1, . . . , Cn output from spread code holding unit 12 as described in conjunction with FIG. 10 and reception signal samples (tap outputs) R0, R1, . . . , Rn output from reception signal holding unit 13 as described in conjunction with FIG. 11 are provided to tap calculating circuit 16.

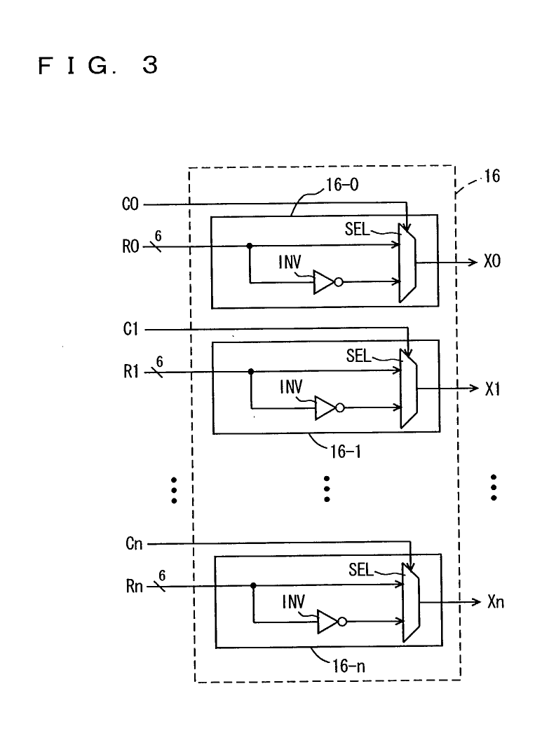

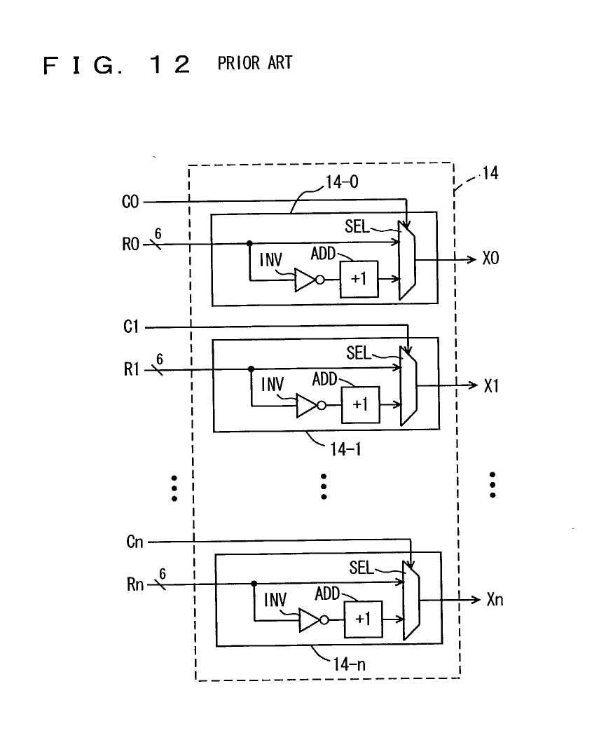

FIG. 3 is a block diagram showing a configuration of tap calculating unit 16. Tap calculating unit 16 shown in FIG. 3 is different from tap calculating unit 14 of the conventional digital matched filter 10 shown in FIG. 12 in the following points.

Tap calculating unit 16 in FIG. 3 also includes a plurality of (256, for example) code control units 16-0, 16-1, . . . , 16-n, each provided for corresponding tap coefficient C and tap output R, as in tap calculating unit 14 in FIG. 12.

Each code control unit constituting tap calculating unit 16 in FIG. 3, however, includes an inverter INV and a selector SEL, and does not include a +1 adder ADD, that was included in each code control unit constituting tap calculating unit 14 in FIG. 12. In other words, in the configuration of FIG. 3, an inverted output from inverter INV is directly provided to the other input of selector SEL in each code control unit.

Therefore, in each of code control units 16-0, 16-1, . . . , 16-n shown in FIG. 3, when a corresponding spread code (tap coefficient) is 1, a 6-bit reception signal sample (tap output) inverted by inverter INV is output as a multiplication result X0, X1, . . . , Xn, without addition of +1 to (carrying) the least significant bit thereof.

Returning to FIG. 2, digital matched filter 100 of the first embodiment of the present invention includes a correction value generating unit 18 receiving a spread code sequence and a control signal from spread code generating unit 11.

Correction value generating unit 18 includes a counter, which counts the number of chips having a value of 1 in the spread code sequence of the spread code length output from spread code generating unit 11. In other words, during a period in which the control signal is 0, correction value generating unit 18 observes, for each chip, the spread codes supplied from spread code generating unit 11, and counts the number of chips having a value of 1.

When the control signal makes a transition from 0 to 1 and the end of the output of the spread code length is notified to correction value generating unit 18, correction value generating unit 18 ends a count operation, and holds the count value. That count value serves as the total number of chips having the value of 1 included in the spread code sequence of the spread code length, for example, of 256 chips.

The number of chips having the value of 1 in the spread code sequence of the spread code length means the number of reception signal samples (tap outputs) to be inverted in tap calculating unit 16 in FIG. 3. Tap calculating unit 16 in FIG. 3 does not add +1 to the tap output to be inverted. Therefore, the sum of the outputs X0 to Xn from tap calculating unit 16 has a smaller value than the proper value, by the number of tap outputs to be inverted, that is, the number of chips having the value of 1 in the spread code length.

Therefore, if the count value of correction value generating unit 18 is added to the sum of the outputs X0 to Xn of tap calculating unit 16 as a correction value, the corrected sum can be obtained as a correlation value output.

Adding unit 17 in FIG. 2 functions so as to add a correction value counted in correction value generating unit 18 to the sum of the multiplication results X0 to Xn output from tap calculating unit 16. Consequently, a correlation value output having an error corrected is supplied from adding unit 17.

When a spread code sequence uniquely fixed at all times is used as a spread code sequence, that is, when the spread code sequence held in spread code holding unit 12 is fixed and already known, the total number of chips having a value of 1 included in that spread code sequence is known in advance. Therefore, if the value is held in advance as a correction value for addition to the sum of the outputs X0 to Xn from tap calculating unit 16 in adding unit 17, it is unnecessary to provide correction value generating unit 18 including a counter.

As described above, according to the first embodiment of the present invention, collective correction to the sum of the outputs from the tap calculating unit will obviate the need for providing a circuit for adding +1 to each tap output. Thus, a circuit configuration of a digital matched filter can be simplified. In particular, when the number of tap outputs increases and many code control units should be provided in the tap calculating unit, this embodiment will be more effective.

(Second Embodiment)

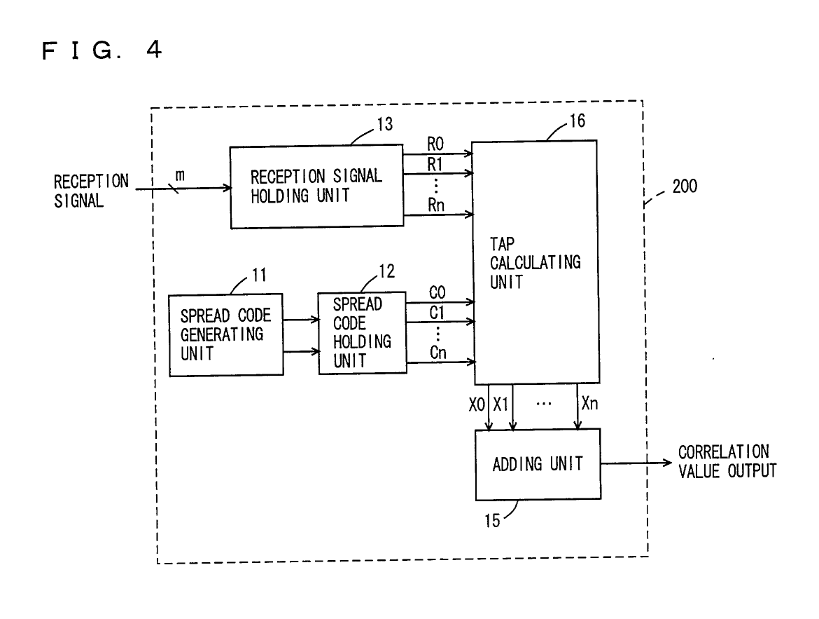

FIG. 4 is a schematic block diagram showing a digital matched filter 200 according to a second embodiment of the present invention, applied to the mobile wireless terminal shown in FIG. 1.

Digital matched filter 200 according to the second embodiment shown in FIG. 4 is different from digital matched filter 100 according to the first embodiment shown in FIG. 2 only in the following points.

Digital matched filter 200 according to the second embodiment shown in FIG. 4 is not provided with correction value generating unit 18 that was provided in digital matched filter 100 according to the first embodiment shown in FIG. 2, and addition of a correction value is not performed in the adding unit. Therefore, adding unit 15 in the conventional example is used as an adding unit. Other configurations are the same as in FIGS. 2 and 3, and description thereof will not be repeated.

Digital matched filter 200 shown in FIG. 4 is not provided with a +1 adder ADD in tap calculating unit 16 as shown in FIG. 3, while collective correction to the sum of the outputs X0 to Xn from tap calculating unit 16 is not performed. Therefore, a correlation value output from adding unit 15 has an error in accordance with the number of chips having a value of 1 in the tap coefficient.

If such an error is within an acceptable range in view of the properties required for the digital matched filter, however, correction value generating unit 18 in FIG. 2 can be eliminated, and the configuration of the digital matched filter can further be simplified.

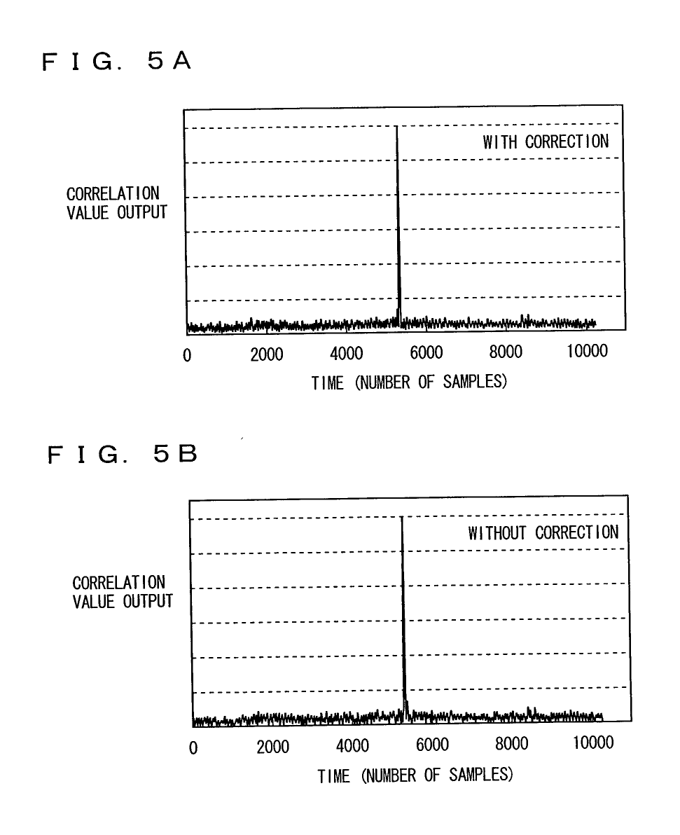

FIG. 5A shows a property of a correlation value output when it is corrected according to the first embodiment in FIG. 2, while FIG. 5B shows a property of the correlation value output when it is not corrected according to the second embodiment in FIG. 4. In each illustration of properties, the abscissa shows a time axis shown by the number of samples, and the ordinate shows a level of the correlation value output.

As will be understood from comparison of both of the above, it is possible to detect a peak of the correlation value output even without correction (FIG. 5B).

As described above, according to the second embodiment of the present invention, correction value generating unit 18 including a counter can be eliminated, and the configuration of the digital matched filter can further be simplified.

In a project called “3rd Generation Partnership Project (3GPP),” standardization of a wide-band CDMA (Wide-Band Code Division Multiple Access) system, which is a next-generation mobile communication system, is promoted.

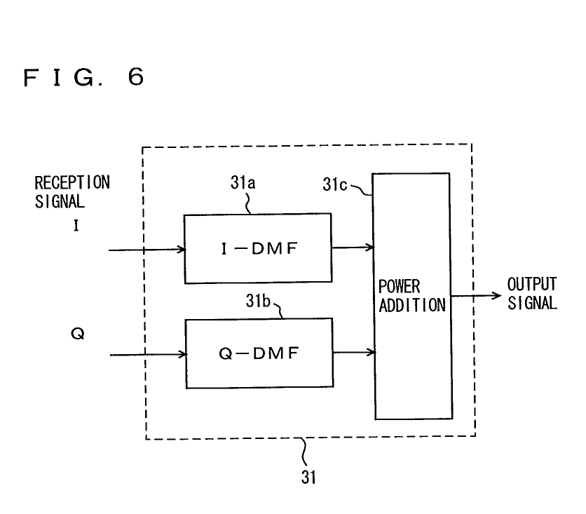

FIG. 6 is a block diagram showing a configuration of a digital matched filter 31 for a downlink synchronization channel (P-SCH: Primary Synchronization Channel) complying with a mode defined by the 3GPP.

The digital matched filter according to the embodiments shown in FIGS. 2 and 4 calculates a correlation value output of an input reception signal of one stream, for the sake of simplicity.

On the other hand, in an example shown in FIG. 6, in the despread unit (66 in FIG. 8) of the receiver, the reception signal of P-SCH is divided into two streams, that is, an I phase (an in-phase component) and a Q phase (a quadrature component), for which the digital matched filters shown in FIG. 2 or 4 according to the present invention are used respectively.

In other words, a digital matched filter (I-DMF) 31a is provided in order to calculate a correlation value of the I phase component of the reception signal of P-SCH with a spread code, and a digital matched filter (Q-DMF) 31b is provided in order to calculate a correlation value of the Q phase component of the reception signal of P-SCH with a spread code.

Each of digital matched filters 31a and 31b is formed by digital matched filter 100 or 200 according to the embodiments of the present invention shown in FIGS. 2 to 4. The correlation value of the I phase component of the reception signal with the spread code, calculated in digital matched filter 31a, is provided to one input of a power adder 31c, while the correlation value of the Q phase component of the reception signal with the spread code, calculated in digital matched filter 31b, is provided to the other input of the same. Power adder 31c integrates and outputs the correlation value of the I phase component and the Q phase component.

An example will be described, in which digital matched filter 100 in the first embodiment of FIG. 2 is used as digital matched filters 31a and 31b.

In P-SCH, a Golay code having a spread code length of 256 chips is adopted as a spread code. In the Golay code, among 256 chips, 120 chips have a value of 1 and 136 chips have a value of 0. In other words, a correction value is 120.

Accordingly, in each of digital matched filters 31a and 31b, using tap calculating unit 16 (FIG. 2), a reception signal sample (tap output) corresponding to the spread code (tap coefficient) of 0 is taken out as it is, and the reception signal sample corresponding to that of 1 is taken out with all bits inverted. The sum of the taken-out tap outputs is calculated by adding unit 17 (FIG. 2), to which the correction value 120 is added.

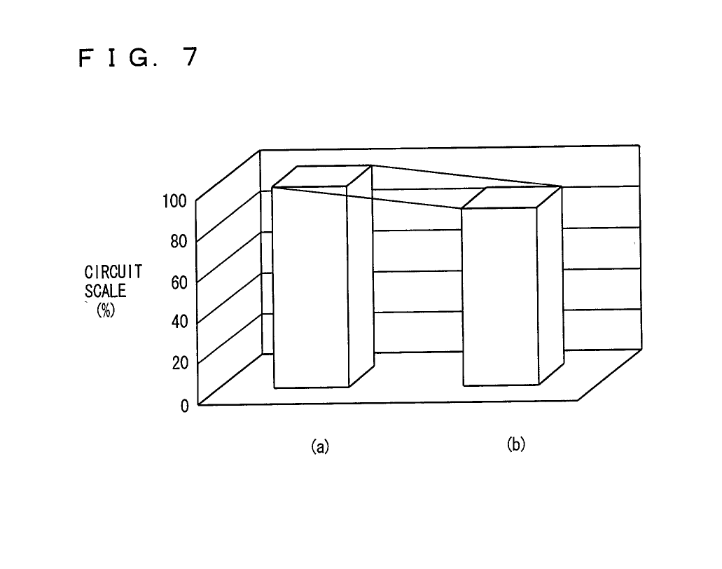

FIG. 7 schematically and visually shows an effect of reducing a circuit scale, when the digital matched filter according to the first embodiment of the present invention is applied as the digital matched filter for P-SCH shown in FIG. 6. Here, (a) in FIG. 7 shows a circuit scale in which digital matched filter 10 (FIG. 9) according to the conventional example is adopted, and (b) shows a circuit scale in which digital matched filter 100 (FIG. 2) according to the present invention is adopted.

As will be apparent from FIG. 7, compared with an example using the conventional digital matched filter, it is understood that the digital matched filter of the present invention implements reduction of the circuit scale.

In each of the embodiments described above, the present invention is applied to an example in which a reception signal sample (tap output) is output as it is when a spread code (tap coefficient) is 0 and the sign of the reception signal sample is inverted when the spread code is 1. The present invention, however, is not limited to such an example. Needless to say, the present invention is similarly applied to an example, for instance, in which the reception signal sample (tap output) is output as it is when the spread code (tap coefficient) is 1 and the sign of the reception signal sample is inverted when the spread code is 0.

As described above, according to the present invention, in each of a plurality of code control units constituting a tap calculating unit, addition of +1 to an inverted tap output is eliminated. Thus, a configuration of the tap calculating unit can be simplified, and in addition, a configuration of a digital matched filter can be simplified.

Further, according to the present invention, collective correction to a correlation value output is performed for a correction value to be added to the correlation value output. Thus, a configuration of each code control unit can be simplified, and a correlation value output without an error can be obtained.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A digital matched filter for performing a despread processing on a reception side to a reception signal sequence subjected to a spread processing on a transmission side, said reception signal sequence composed of samples each having a prescribed number of bits, comprising:
a reception signal holding unit sequentially holding a prescribed number of said samples constituting said reception signal sequence that is time-sequentially input;
a spread code supply unit supplying a spread code sequence for said despread processing; and
a correlation value calculating unit calculating a correlation value of at least a portion of said prescribed number of samples held in said reception signal holding unit with a spread code corresponding to at least the portion of said samples in said supplied spread. code sequence; wherein
said correlation value calculating unit includes
a plurality of code control units each provided for corresponding said sample and said spread code, and
an adding unit calculating a sum of outputs from said plurality of code control units; and
each of said plurality of code control units outputs a corresponding sample as it is when a corresponding spread code has a first value, and provides an output having said prescribed number of bits of a corresponding sample all inverted when the corresponding spread code has a second value different from said first value.

2. The digital matched filter according to claim 1, wherein
said correlation value calculating unit further includes a correction unit adding as a correction value, a number of codes having said second value among the spread codes corresponding to at least the portion of said samples to said sum calculated in said adding unit.

3. The digital matched filter according to claim 2, wherein
said correction unit includes a count unit counting a number of codes having said second value among the spread codes corresponding to at least the portion of said samples and supplying the number as said correction value.

4. The digital matched filter according to claim 2, wherein
said supplied spread code sequence is a fixed spread code sequence, and said correction unit includes a holding unit holding in advance as said correction value, the number of codes having said second value among said fixed spread codes corresponding to at least the portion of said samples.

5. A mobile wireless terminal for digital radio communication, comprising:
a reception-related modem demodulating received digital data; and
a signal processing device processing and outputting a reception signal of said reception-related modem; wherein
said reception-related modem includes a digital matched filter for performing a despread processing on a reception side to a reception signal sequence subjected to a spread processing on a transmission side, said reception signal sequence composed of samples each having a prescribed number of bits;
said digital matched filter includes
a reception signal holding unit sequentially holding a prescribed number of said samples constituting said reception signal sequence that is time-sequentially input,
a spread code supply unit supplying a spread code sequence for said despread processing, and
a correlation value calculating unit calculating a correlation value of at least a portion of said prescribed number of samples held in said reception signal holding unit with a spread code corresponding to at least the portion of said samples in said supplied spread code sequence;
said correlation value calculating unit includes
a plurality of code control units each provided corresponding said sample and said spread code, and
an adding unit calculating a sum of outputs from said plurality of code control units; and
each of said plurality of code control units outputs a corresponding sample as it is when a corresponding spread code has a first value, and provides an output having said prescribed number of bits of a corresponding sample all inverted when the corresponding spread code has a second value different from said first value.

6. The mobile wireless terminal according to claim 5, wherein
said correlation value calculating unit further includes a correction unit adding as a correction value, a number of codes having said second value among the spread codes corresponding to at least the portion of said samples to said sum calculated in said adding unit.

7. The mobile wireless terminal according to claim 6, wherein
said correction unit includes a count unit counting a number of codes having said second value among the spread codes corresponding to at least the portion of said samples and supplying the number as said correction value.

8. The mobile wireless terminal according to claim 6, wherein
said supplied spread code sequence is a fixed spread code sequence, and said correction unit includes a holding unit holding in advance as said correction value, the number of codes having said second value among said fixed spread codes corresponding to at least the portion of said samples.
